(19) United States
(12) Patent Application Publication
(10) Pub. No.: US 2024/0041245 A1
(43) Pub. Date: Feb. 8, 2024

(54) DISPENSING NOZZLE FOR A MILK MODULE FOR PRODUCING HOT OR COLD, FOAMED OR NON-FOAMED MILK

(71) Applicant: RHEAVENDORS INDUSTRIES S.P.A., Como (IT)

(72) Inventors: Ezio CERIANI, Como (IT); Giuseppe Antonio Ercolino SISTO, Como (IT)

(21) Appl. No.: 18/266,572

(22) PCT Filed: Dec. 10, 2021
(86) PCT No.: PCT/IB2021/061572

§ 371 Date: Jun. 9, 2023

(30) Foreign Application Priority Data
Dec. 10, 2020 (IT) 102020000030392

(51) Int. Cl. A47J 31/44; A47J 31/46; A47J 31/60

(52) U.S. Cl. CPC A47J 31/4485; A47J 31/461; A47J 31/469; A47J 31/60

(57) ABSTRACT

A milk module for producing hot or cold, foamed or non-foamed milk, and integrable in a machine for producing milk-based beverages. The milk module comprises a supply pump: a suction line extending from a fluid inlet to a suction side of the supply pump: a delivery line extending from a delivery side of the supply pump to a dispensing nozzle with an inlet portion and a dispensing outlet: an electronic control unit configured to operate the milk module in a production mode, in which the suction line is supplied with milk, and in a washing mode, in which the suction line is supplied with either water or water and detergent: and a drainage line to drain washing water into a waste container during operation in the washing mode. The drainage line extends from the dispensing nozzle to the waste container and comprises a suction pump.

### CROSS-REFERENCE TO RELATED APPLICATIONS

This patent application claims priority to Italian patent application 102020000030392 filed on 10 Dec. 2020, the content of which is incorporated herein by reference.

### TECHNICAL FIELD OF THE INVENTION

The invention relates to a dispensing nozzle for a milk module for producing hot or cold, foamed or non-foamed milk, and integrable in a machine for producing milk-based beverages. In particular, the invention finds advantageous application in table-top machines for producing milk-based beverages, to which reference will be made in the description without loosing in generality.

### STATE OF THE ART

As is known, in the above-mentioned beverage production machines, the milk module usually comprises a washing circuit designed to periodically clean all those components of the milk module that, in use, come into contact with milk and, for this reason, are likely to be subjected to the proliferation of bacteria. Usually, the milk module is subjected to a water rinsing process at the end of each milk-based beverage producing cycle and a more in-depth washing process with water and detergent when the beverage production machine is not operating, normally at the end of a work day.

A known milk module usually comprises a milk line provided with a pump for sucking fresh milk from a milk container, a foaming device, a heating device and a dispensing nozzle, through which hot or cold, foamed or non-foamed milk is delivered into a cup or similar container.

During rinsing and washing processes, a given amount of water or water and detergent is cause to flow along the milk line and is drained into a waste container, normally via a valve.

In the table-top machines for producing milk-based beverages, the milk dispensing nozzle is usually stationary in a beverage dispensing compartment, so the washing liquid is normally prevented from flowing up to the beverage dispensing nozzle and is drained towards the waste container in a point of the milk line upstream of, and at a given distance from, the beverage dispensing nozzle. As a result, the end part of the milk line or, at least, the beverage dispensing nozzle is never involved in the washing process and require a manual cleaning intervention by an operator, who normally removes the beverage dispensing nozzle and washes it separately.

### OBJECT AND SUMMARY OF THE INVENTION

The object of the present invention is to provide a dispensing nozzle for a milk module for producing hot or cold, foamed or non-foamed milk and integrable in a machine for producing milk-based beverages, the dispensing nozzle allowing the efficiency of the washing of both the dispensing nozzle and of those components of the milk module upstream of the dispensing nozzle and which, in use, come into contact with milk to be improved compared to known milk modules.

According to the present invention, a dispensing nozzle for a milk module for producing hot or cold, foamed or non-foamed milk and integrable in a machine for producing milk-based beverages is provided, as claimed in the appended claims.

According to the present invention, a milk module for producing hot or cold, foamed or non-foamed milk and a machine for producing milk-based beverages are also provided, as claimed in the appended claims.

### BRIEF DESCRIPTION OF THE DRAWINGS

FIG. 1 shows a hydraulic circuit of a preferred embodiment of a machine for producing milk-based beverages according to the present invention.

FIGS. 2 and 3 show, in a perspective view, a detail of the machine for producing milk-based beverages shown in FIG. 1.

FIG. 4 is a sectional view from the bottom of the detail shown in FIGS. 2 and 3.

### DESCRIPTION OF PREFERRED EMBODIMENTS OF THE INVENTION

The invention will now be described in detail with reference to the attached figure to enable a skilled person to realize and use it. Various modifications to the embodiments presented shall be immediately clear to persons skilled in the art and the general principles disclosed herein could be applied to other embodiments and applications but without thereby departing from the scope of protection of the present invention as defined in the appended claims. Therefore, the present invention should not be considered limited to the embodiments described and shown but should be granted the widest protective scope in accordance with the features described and claimed.

Where not otherwise defined, all the technical and scientific terms used herein have the same meaning commonly used by persons of ordinary skill in the field pertaining to the present invention. In the event of a conflict, this description, including the definitions provided, shall be binding. Furthermore, the examples are provided for illustrative purposes only and as such should not be considered limiting.

In order to facilitate understanding of the embodiments described herein, reference will be made to some specific embodiments and a specific language will be used to describe them. The terminology used herein is for the purpose of describing only particular embodiments, and is not intended to limit the scope of the present invention.

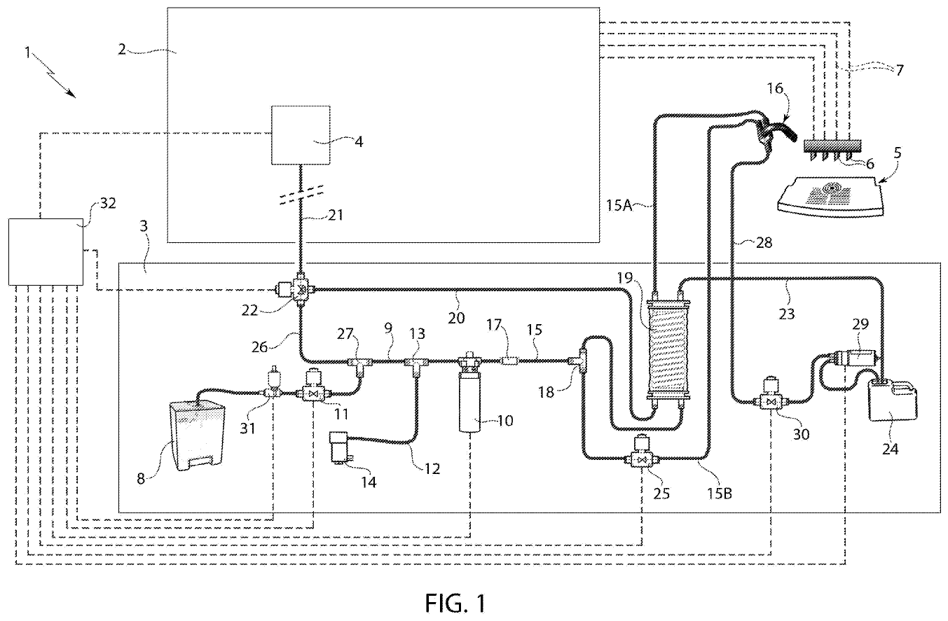

FIG. 1 schematically shows a machine 1 for producing milk-based beverages and comprising a brewing unit 2 to produce beverages such as espresso and beverages from soluble products, and a milk module 3 to produce of hot or cold, foamed or non-foamed milk.

The brewing unit 2 comprises a plurality of conventional functional assemblies and, for this reason, will not be described in detail. In general, the brewing unit 2 comprises a brewer (not shown) to produce espresso, one or more mixers (not shown) to produce beverages from soluble products, a heater 4 to produce hot water or steam, and a pump (not shown) to supply the brewer and the mixers with hot water required to produce beverages.

The machine 1 further comprises a beverage dispensing compartment 5, where a group of dispensing nozzles 6 are arranged, which are fluidically connected to the brewing unit 2 via respective supply lines 7 to receive, in use, beverages produced by the brewing unit 2 and dispense them into a cup or similar container (not shown) on a cup-carrier grid in the beverage dispensing compartment 5.

The milk module 3 is selectively fluidically connectable to the brewing unit 2, more precisely to the heater 4, to receive, during operation, steam and hot water to be used, as explained more in detail below, to heat the milk and, respectively, to wash those components of the milk module 3 that, in use, come into contact with the milk and, hence, that need a regular cleaning in order to avoid the proliferation of bacteria.

FIG. 1 schematically shows a hydraulic circuit of the milk module 3, which comprises: a milk container 8, which is preferably arranged inside a refrigerated area to keep the milk at a temperature ranging from 3° to 5°;
a suction line 9 having a first end immersed in the milk container 8 and a second end fluidically connected to the suction side of a pump 10, preferably a gear pump; the inflow of milk into the suction line 9 is controlled by a shut-off valve 11;
an air line 12, through which an ambient air flow is introduced into the suction 9 at a T joint 13 arranged upstream of the pump 10. The inflow of air into the air line 12 is controlled by a valve 14, which enables or inhibits the introduction of an air flow into the air line 12 depending on whether foamed or non-foamed milk, respectively, has to be produced. Conveniently, the valve 14 is a proportional solenoid valve, which allows the air flow rate to be adjusted according to closed-loop or open-loop control algorithms, which are widely known in the sector; and
a delivery line 15 designed to convey milk or milk and air mixture from the pump 10 to a milk dispensing nozzle 16 which is arranged in the beverage dispensing compartment 5 and is part of the group of dispensing nozzles 6.

The delivery line 15 has, downstream of the pump 10, a flow restriction 17 which defines a concentrated reduction of the cross section of the delivery line 15 so as to causa, in use, the milk and air mixture flowing therethrough to be subjected to a quick compression and to a successive quick expansion, which transforms, based on a principle well known to a person skilled in the art, the milk and air mixture into foamed milk.

The flow restriction 17 can be formed by a non-adjustable nozzle or by a baffle or by a throttle valve, which may be either adjustable or non-adjustable.

Downstream of the flow restriction 17, the delivery line 15 has a bifurcation 18, from which two parallel ducts branch off and both open into the milk dispensing nozzle 16. One of the two ducts, hereinafter referenced with 15A, supplies foamed or non-foamed hot milk to the milk dispensing nozzle 16, whereas the other one of the two ducts, hereinafter referenced with 15B, supplies foamed or non-foamed cold milk to the milk dispensing nozzle 16.

The milk or the foamed milk flowing in the duct 15A is heated by a heater 19, which, according to a preferred embodiment shown in FIG. 1, is in the form of a heat exchanger, in which the milk or the foamed milk is indirectly heated by a steam flow supplied to a cylindrical duct which winds around a spiral-shaped portion of the duct 15A.

The steam flow supplied to the heater 19 is produced by the heater 4 of the brewing unit 2 and is conveyed to the heater 19 by a steam line 20 with a first end fluidically connected, via a three-way valve 22, to a hot water/steam supply duct 21, which, in turn, is directly or indirectly connected to an outlet of the heater 4, and with a second end fluidically connected to an inlet of the spiral-shaped duct of the heater 19 to supply the latter with the steam flow.

On the opposite side, the spiral-shaped duct of the heater 19 has an outlet fluidically connected to a discharge line 23 designed to convey duct into a waste container 24 condensation water that is formed, during operation, by the cooling of the steam along the spiral-shaped duct.

Preferably, no shut-off valves are provided along the duct 15A and, hence, the delivery line 15 is always in fluid communication with the milk dispensing nozzle 16, regardless of whether steam is supplied to the heater 19 or not.

Along the duct 15B a shut-off valve 25 is instead provided, which can be operated so as to allow the foamed or non-foamed cold milk to flow along the duct 15B or prevent it from flowing depending on the type of beverage to be produced, as described more in detail below.

The milk module 3 further comprises a washing circuit having the function of washing the ducts of the milk module 3 where milk flows, both by a mere rinsing with water at the end of each milk-based beverage producing cycle or after the milk module 3 has not been used for a given amount of time, and by a more in-depth washing with detergent, which is normally carried out when the machine 1 is turned off, for example at the end of the day.

The washing circuit comprises a hot water supply line 26 to supply the suction line 9 with a hot water flow from the heater 4. The hot water supply line 26 has an inlet coupled to an outlet of the three-way valve 22 to selectively fluidically communicate with the hot water/steam supply duct 21 and receive hot water from the heater 4. The supply line 26 opens into the suction line 9 at a T joint 27 between the shut-off valve 11 and the T joint 13, where the air line 12 open into the suction line 9.

The washing circuit further comprises a drainage line 28 having the function of conveying either rinsing hot water or water and washing detergent mixture flowing in the delivery line 15, namely from the outlets of the ducts 15A and 15B, into the waste container 24 so as to prevent it from reaching the outlet of the milk dispensing nozzle 16.

Conveniently, the drainage line 28 is enabled during rinsing and washing operations to suck hot water or water and detergent mixture flowing along the suction line 9 and the delivery line 15 and, at the beginning of each milk-based beverage producing cycle, to suck the water that, after each rinsing, remains along the suction line 9 and the delivery line 15.

According to a preferred embodiment shown in FIG. 1, the drainage line 28 has a first end fluidically connected to the milk dispensing nozzle 16 upstream of the outlet thereof and a second end that opens into the waste container 24, and comprises a pump 29 and a shut-off valve 30, which is arranged on the suction side of the pump 29 and has the function of causing, when it is closed, the milk dispensing nozzle 16 to be fluidically isolated from the waste container 24.

Optionally, the shut-off valve 30 can be omitted if the pump 29 is so designed so as to cause, when it is turned off, a fluid-tight separation between its suction and delivery sides.

The operation of the milk module 3 will be described below with reference to three different operating steps:
1) production of hot or cold, foamed or non-foamed milk;
2) rinsing with hot water at the end of a milk-based beverage producing cycle;
3) the washing with detergent when the machine is not working.

### 1) Production of Hot or Cold Foamed or Non-Foamed Milk

In response to a selection of a milk-based beverage, the electronic control unit 32 of the machine 1 operates the pump 10 to cause a given amount of milk to be sucked out of the milk container 8 and supplied to the delivery line 15. If foamed milk is required, the electronic control unit 32 opens the valve 14 to allow a given quantity of air to flow into the air line 12 and be sucked into the milk flowing along the suction line 9. The pump 10 is then operated to cause the milk and air mixture to flow through the flow restriction 17 in order to be transformed, in a cold state, into foamed milk.

If foamed or non-foamed hot milk is required, the electronic control unit 32 closes the shut-off valve 25 along the duct 15B to prevent milk from flowing therealong and operates the heater 4 of the brewing unit 2 to cause steam to be produced and supplied to the hot water/steam supply duct 21. At the same time, the three-way valve 22 is controlled so as to cause the steam produced by the heater 4 to be supplied to the heater 19 to heat the foamed or non-foamed milk flowing along the duct 15B.

If foamed or non-foamed cold milk is required, the shut-off valve 25 of the duct 15B is opened in order to allow milk to flow therethrough, whereas the three-way valve 22 is controlled to prevent steam from being supplied to the heater 19. In this way, foamed or non-foamed cold milk reaches the milk dispensing nozzle 16 flowing through both ducts 15A and 15B.

It is worth noting that, if the milk module 3 is required to produce hot milk immediately before the production of cold milk, the heater 19, even if it is not supplied with steam, preserves some residual heat which heats to a low extent the cold milk flowing along the duct 15A. However, this heating fails to adversely affect the final temperature of the cold milk dispensed because the amount of cold milk flowing along the duct 15B is greater than the amount of milk flowing along the duct 15A and the low temperature of the cold milk along the duct 15B mitigates the temperature increase in the milk flowing along the duct 15A. The grater milk flow in the duct 15B compared to the duct 15A, when the shut-off valve 25 is open, derives from the heater 19 defining, due to its own conformation, a hydraulic resistance that counters to a certain extent the flow of milk along the duct 15A and, resultingly, causes the duct 15B to become a preferred path for the milk downstream of the bifurcation 18.

2) Rinsing with Hot Water

At the end of a milk-based beverage producing cycle, the milk module 3 is subjected to a hot water rinsing in order to eliminate milk residues present along the suction line 9 and the delivery line 15 and in the different operating components distributed therealong.

The hot water used for rinsing is produced by the heater 4 and supplied to the water/steam supply line 21.

During rinsing, the electronic control unit 32 closes the shut-off valve 11 to fluidically isolate the milk container 8, opens the shut-off valve 25 to allow milk to flow along the duct 15B, and closes the valve 14 at the inlet of the air line 12.

At the same time, the three-way valve 22 is controlled so as to cause water to flow from the water/steam supply line 21 to the hot water supply line 26, and the pump 10 is operated to cause hot water to flow, through the pump 10, from the suction line 9 to the delivery line 15 and, through both ducts 15A and 15B, reach the milk dispensing nozzle 16.

Operation of the pump 29 prevents hot water, once it has entered the milk dispensing nozzle 16, from reaching the outlet of the dispensing nozzle 16. As a matter of fact, hot water is sucked by the pump 29 immediately upstream of the outlet of the dispensing nozzle 16 and is conveyed, through the drainage line 28, into the waste container 24. The shut-off valve 30 is obviously open during this step. After a given amount of time has elapsed, during which a predetermined amount of hot water flows along the suction line 9 and the delivery line 15, the supply of hot water is interrupted, the pump 29 is stopped and the shut-off valve 30 is closed.

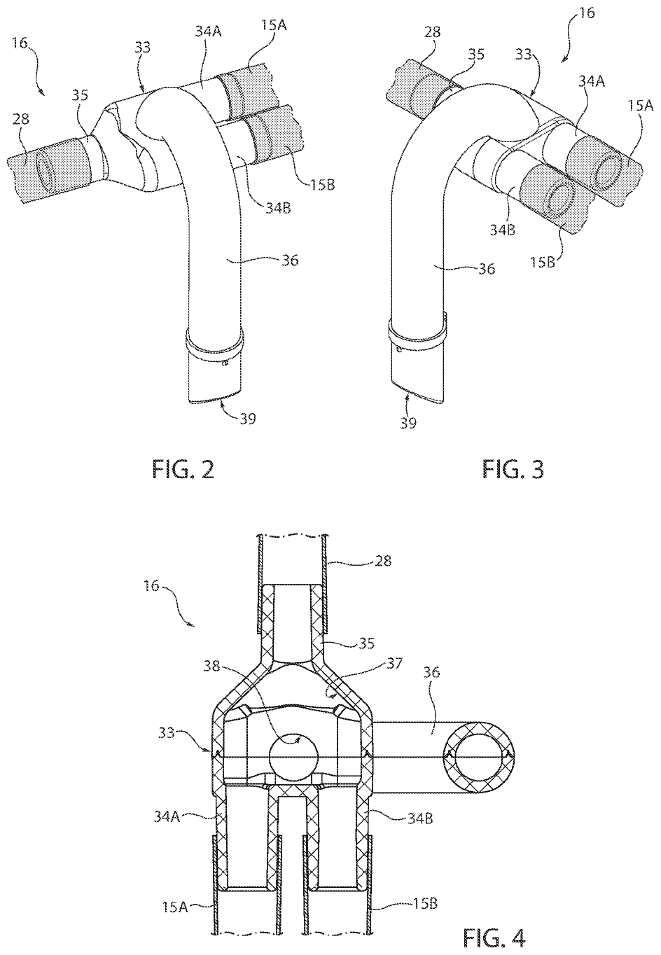

It is worth noting that during the suction generated by the pump 29, drainage of the water flowing out of the ducts 15A and 15B is substantially total, which means that not even a part of water reaches the outlet of the milk dispensing nozzle 16. This is possible thanks to the combined action of the suction force and of the position of the inlet of the drainage line 28 with respect to the outlets of the ducts 15A and 15B and the outlet of the milk dispensing nozzle 16. To this aim, the milk dispensing nozzle 16 can have different conformations, provided that they are designed so that the inlet of the drainage line 28 is, for the water coming from the ducts 15A and 15B, a preferred path compared to the outlet of the milk dispensing nozzle 16. A preferred embodiment of the milk dispensing nozzle 16 is shown in FIGS. 2 to 4 and will be described below in more detail.

At the end of the rinsing, the suction line 9 and the delivery line 15 remain full of water, which is sucked at the beginning of the following milk production cycle by operating the pump 29 for a predetermined amount of time, which is calculated based on the water volume to be sucked. Preferably, at the beginning of a new milk producing cycle, the pump 29 is operated at least for an amount of time enough to suck the water contained in the part of circuit upstream of the milk dispensing nozzle 16. When the pump 29 is stopped and the shut-off valve 30 is closed, a new beverage producing cycle may commence.

Preferably, the above-described rinsing is carried out, as mentioned before, after each milk-based beverage producing cycle and after a predetermined amount of time during which the milk module 3 is inoperative. According to an alternative operating mode, the rinsing is not carried out after each milk-based beverage production cycle, but only when a given amount of time, for example a few minutes, has elapsed since the last time a milk-based beverage was dispensed. This operating mode has the advantage of optimizing cycle times, in case two or more beverages are produced in very close succession.

3) Washing with Detergent

As already mentioned above, this in-depth washing is periodically carried out when the machine 1 is inoperative, typically at the end of a work day.

This in-depth washing comprises the three sub-steps described below:
i. The inlet of the suction line 9 is extracted, usually manually by an operator, from the milk container 8 and is inserted into another container (not shown) containing a detergent, preferably in the form of a tablet or of a concentrated liquid. The electronic control unit 32 is configured to cause, during this step, the shut-off valve 11 between the container with the detergent and the T joint 27 to open, the valve 14 of the air line 12 to close and the pump 10 to be inoperative so as to fluidically separate the suction line 9 from the delivery line 15. The three-way valve 22 is controlled to allow hot water to flow from the water/steam supply duct 21 to the hot water supply line 26 so as to reach, through the suction line 9, and fill the container containing the detergent, thus forming a water and detergent mixture.
ii. Once the container has been filled with hot water, the supply of hot water is interrupted and the pump 10 is operated to extract the water and detergent mixture from the container and cause it to flow along the suction line 9 and along both ducts 15A and 15B of the delivery line 15. Simultaneously with the pump 10, also the pump 29 is operated to suck the washing mixture and convey it, through the drainage line 28, to the waste container 24.
iii. Once the container is empty, at least one rinsing with clean hot water is carried out. To this aim, the above-described sub-steps i and ii are sequentially repeated, with the sole difference that no detergent is added to the container. Sub-steps i and ii are repeated, if necessary, until no more traces of detergent are detected in the rinsing water. To this aim, a conductivity sensor 31 may be used, which is preferably arranged close to the inlet of the suction line 9. At the end of the rinsing, the inlet of the suction line 9 is placed again in the milk container 8 and the milk module 3 is ready for a new production cycle.

Conveniently, both during the washing with detergent and the rinsing with hot water, the pump 29 is stopped for a few instants and then operated again, so that, in the instants in which it is inoperative, a small amount of water flows through the outlet of the milk dispensing nozzle 16 to remove milk residues possibly present between the inlet of the drainage line 28 and the outlet of the milk dispensing nozzle 16.

In the end, before the washing with detergent a small amount of hot or cold water is preferably caused to flow along the suction line 9 and the delivery line 15 and, then, sucked in the area of the milk dispensing nozzle 16 in order to reduce the quantity of residual milk present in the circuit.

In view of the foregoing, the advantage arising from the sucking of waste water through the pump 29 arranged on the drainage line 28 may be appreciated. By so doing, indeed, all components coming into contact with milk can be washed, included the entire delivery line 15 and part of the milk dispensing nozzle 16, without having waste water flowing in the beverage dispensing compartment 5.

FIG. 2 shows, by way of example, a milk dispensing nozzle 16, whose geometry is particularly advantageous, in combination with the suction effect of the pump 29, to achieve the above-indicated advantages.

In particular, the milk dispensing nozzle 16 shown in FIG. 2 comprises a collector body 33 having:
two inlet hose connectors 34A and 34B, to which the outlet ends of the ducts 15A and 15B, respectively, are coupled,
an outlet hose connector 35, to which the inlet end of the drainage line 28 is coupled, and
a dispensing duct 36, through which the milk flowing into the collector body 33 through the ducts 15A and 15B is dispensed into a glass in the beverage dispensing compartment 5.

As shown in FIGS. 2, 3 and 4, the inlet hose connectors 34A and 34B and the outlet hose connector 35 are arranged on opposite sides of the collector body 33 and have respective mutually parallel axes lying in one and the same plane. In a preferred embodiment shown in FIGS. 2, 3 and 4, the lying plane is, in use, substantially horizontal. In alternative embodiments (not shown), however, the lying plane may be oriented differently, in particular it could be arranged so that the inlet hose connectors 34A and 34B are arranged at a higher level than the outlet hose connector 35.

The collector body 33 defines an inner chamber 37, which has, in a horizontal cross section, the shape of a funnel and communicates, in the larger area of its section, with the two inlet hose connectors 34A and 34B and, in the narrower area of its section, with the outlet hose connector 35.

The dispensing duct 36 extends from the top of the collector body 33 and communicates with the chamber 37 through a hole 38 formed in an upper wall of the collector body 33 and having an axis that is substantially perpendicular to the lying plane of the axes of the inlet hose connectors 34A and 34B and of the outlet hose connector 35.

As shown in FIGS. 2 and 3, the dispensing duct 36 develops in a vertical plane and comprises a proximal inverted U-shaped portion and a distal straight portion ending with the milk outlet 39.

The particular shape of the collector body 33 and the relative position of the inlet hose connectors 34A and 34B, of the outlet hose connector 35 and of the dispensing duct 36 cause, during washing, during which the shut-off valve 30 is open and the pump 29 is operating, the drainage line 28 to represent a preferred path for the water coming from the ducts 15A and 15B and reaching the chamber 37. Indeed, since the outlet hose connector 35 substantially faces the inlet hose connectors 34A and 34B in a supply direction of the flow that, through the inlet hose connectors 34A and 34B, enters the chamber 37, the water flow into the chamber 37 is caused to flow in the same direction and, hence, to flow into the outlet hose connector 35, rather than make a 900 deflection and flow into the dispensing duct 36. Besides the position of the hole 38, the inverted U shape of the proximal portion of the dispensing duct 36 also helps make the flow of water in the dispensing duct 36 less easy than it is in the outlet hose connector 35.

The joined effect of the geometry of the milk dispensing nozzle 16 and of the suction force generated by the pump 29 results in the total convergence of the water flow towards the drainage line 28 and prevents water from reaching, even if in a very small amount, the milk outlet 39.

Preferably, the ducts 15A and 15B and the drainage line 28 are formed by flexible hoses and the inlet hose connectors 34A and 34B and the outlet hose connector 35 are hose male quick connectors, where the ends of the ducts 15A and 15B and the inlet end of the drainage line 28, respectively, are coupled through pressing.

Furthermore, the collector body 33 is preferably formed by two shells, which are manufactured by plastic material moulding and are mutually coupled by ultrasound welding.

In an alternative embodiment (not shown), the ducts 15A and 15B converge in a common end segment before joining the milk dispensing nozzle 16, which, as a consequence, has a single inlet hose connector connected to the end segment.

1. A dispensing nozzle for a milk module for producing hot or cold, foamed or smooth milk, and integrable in a machine for producing milk-based beverages;
the dispensing nozzle comprises a collector body having an internal chamber and comprising at least one inlet connector, an outlet connector, and a milk dispensing duct through which hot or cold, foamed or smooth milk is dispensed in a container;
the inlet connector is designed to be connected to a supply line to receive therefrom milk when the milk module is caused to operate in a production mode, and a washing liquid when the milk module is caused to operate in a washing mode; and
the outlet connector is in fluid communication with the chamber to receive therefrom the washing liquid when the milk module is caused to operate in the washing mode to supply the washing liquid to a drainage line;
the inlet connector, the outlet connector and the milk dispensing duct open into the chamber and are arranged so that the outlet connector substantially faces the inlet connector in a direction of supply of the washing liquid into the chamber, and the milk dispensing duct is arranged so that the washing liquid may flow therein in a direction substantially transversal to said direction of supply, so as to result in the outlet connector representing a preferred path for the washing liquid with respect to the milk dispensing duct.

2. The dispensing nozzle of claim 1, wherein the direction of supply is substantially horizontal and the milk dispensing duct is arranged to cause the washing water to flow therein via an upwards deviation.

3. The dispensing nozzle of claim 1, wherein the at least one inlet connector and the outlet connector have respective mutually parallel axes lying in one and the same plane; the milk dispensing duct has an inlet having an axis substantially perpendicular to the lying plane of the axes of the inlet connector and of the outlet connector.

4. The dispensing nozzle of claim 3, wherein the axes of the inlet connector and of the outlet connector lie in a horizontal plane and the axis of the inlet of the milk dispensing duct is vertical.

5. The dispensing nozzle of claim 1, wherein the milk dispensing duct extends in a vertical plane from the top of the collector body of the dispensing nozzle and comprises a proximal inverted U-shaped portion and a distal straight portion ending with the dispensing outlet.

6. The dispensing nozzle of claim 1, wherein the chamber is funnel-shaped and has a wider section, in which the at least one inlet connector opens, and a narrower section, in which the outlet connector opens.

7. A milk module for producing hot or cold, foamed or non-foamed milk, integrable in a machine for producing milk-based beverages, and comprising the dispensing nozzle of claim 1; a supply line; a drainage line; and an electronic control unit configured to cause the milk module to operate in a production mode, in which the suction line is supplied with milk, and in a washing mode, in which the suction line is supplied with washing liquid;
wherein the drainage line extends from the dispensing nozzle to a waste container and comprises a suction pump;
wherein the supply line comprises:
a supply pump;
a suction line extending from a fluid inlet to a suction side of the supply pump;
a delivery line extending from a delivery side of the supply pump to the dispensing nozzle;
and wherein the electronic control unit is further configured to cause the suction line to be supplied with milk during the production mode and with washing liquid during the washing mode.

8. The milk module of claim 7, wherein the delivery line comprises a bifurcation, at which the delivery line divides into two delivery ducts which open into the dispensing nozzle either separately or via a common terminal portion;
wherein, when the delivery ducts open into the dispensing nozzle via a common terminal portion, the collector body of the dispensing nozzle comprises a single inlet connector fluidically connected to the common terminal portion;
and wherein, when the delivery ducts open into the dispensing nozzle separately, the collector body of the dispensing nozzle comprises two inlet connectors, each of which is associated to a respective delivery duct; the two inlet connectors open into the chamber in such a way that they both substantially face the outlet connector in the direction of supply of the fluid into the chamber.

9. The milk module of claim 8, wherein the delivery line further comprises a heater arranged along one of the two delivery ducts and selectively operable to heat milk; and an electronically-controllable shut-off valve arranged along the other of the two delivery ducts and selectively operable to allow milk to flow therethrough.

10. The milk module of claim 7, further comprising an air line to controllably supply air into the suction line; and a flow restriction arranged downstream of the supply pump to transform, when the milk module operates in the production mode, an air/milk mixture into foamed milk.

11. The milk module of claim 7, further comprising:
a first valve device arranged between the fluid inlet of the suction line and the supply pump;
a water supply line to supply water to the suction line at an emanation point between the first valve device and the supply pump; and
a second valve device operable to cause the water supply line to be selectively supplied with water;
wherein the electronic control unit is further configured to operate the milk module in a first washing mode, preferably either between two successive production cycles or after a certain period of time;
and wherein, in the first washing mode, the electronic control unit is further configured to:
control the first valve device and the second valve device to cause water to flow into the water supply line and, therefrom, into the suction line without reaching the fluid inlet of the suction line; and
co-ordinately operate the supply pump and the suction pump to cause water to flow along the suction line, the delivery line and the drainage line.

12. The milk module of claim 7, wherein the electronic control unit is further configured to operate the milk module in a second washing mode, preferably at the end of the daily service;
wherein, during the first washing mode, the fluid inlet of the suction line is immersed in a milk container and during the second washing mode the fluid inlet of the suction line is immersed in a detergent container;
and wherein, in the second washing mode, the electronic control unit is further configured to:
control the first valve device and the second valve device to cause water to flow into the water supply line and reach the fluid inlet of the suction line and fill the detergent container;
when the detergent container is full, co-ordinately operate the supply pump and the suction pump and control the first valve device and second valve device to prevent water from flowing in the water supply line and to cause the water/detergent mixture in the detergent container to flow along the suction line, the delivery line and the drainage line.

13. A machine for producing milk-based beverages and comprising the milk module of any one of claim 7.
